(19) United States
(12) Patent Application Publication
(10) Pub. No.: US 2023/0036378 A1
(43) Pub. Date: Feb. 2, 2023

(54) PROCESS FOR PREPARING A HARD CARAMEL CONTAINING A TREHALULOSE-CONTAINING COMPOSITION

(71) Applicant: Südzucker AG, Mannheim (DE)

(72) Inventors: Ingrid Willibald-Ettle, Landau (DE); David Richfield, Worms (DE); Jörg Willfahrt, Monsheim (DE); Christina Lutz, Gipf-Oberfrick (CH); Raymond Place, Basel (CH)

(21) Appl. No.: 17/783,391

(22) PCT Filed: Dec. 9, 2020
(86) PCT No.: PCT/EP2020/085308

§ 371 Date: Jun. 8, 2022

(30) Foreign Application Priority Data
Dec. 11, 2019 (DE) 10 2019 219 323.4

(51) Int. Cl. A23G 3/42; A23G 3/34

(52) U.S. Cl. CPC A23G 3/42; A23G 3/0014; A23G 3/0012; A23G 3/0025; A23V 2002/00

(57) ABSTRACT

The present invention relates to a process for preparing a hard caramel containing a trehalulose-containing composition, and to a hard caramel prepared according to the process.

The present invention relates to a process for preparing a hard caramel containing a trehalulose-containing composition, and to a hard caramel prepared according to the process.

Currently, there are many different sugar-containing and sugar-free hard caramel products in various forms on the market. The growing interest among the population in sugar-free alternatives to common hard caramels while maintaining the appearance, shelf life and mouthfeel of such hard caramels has led to the development of a variety of sugar substitute hard caramels in recent years.

Vitalose® is a sweet, transparent syrup mainly composed of the two disaccharides trehalulose (1-O-α-D-glucopyranosyl-D-fructose) and isomaltulose (6-O-α-D-glucopyranosyl-D-fructose) with a mild sugary sweetness profile without any off-flavours or off-colours. Vitalose® also features a low glycaemic index (GI). The trehalulose contained in Vitalose® leads to a similar blood sugar response when consumed as isomaltulose, which is also contained in the product, but results in a lower insulin release. In addition to the lower glycaemic index (GI) and reduced insulin release compared to sucrose, the sugar substitutes isomaltulose and trehalulose contained in Vitalose® provide the energy contained in the molecules more evenly and over a longer period of time.

However, due to its syrup-like consistency and sucrose-like hygroscopicity, Vitalose® cannot always be processed into hard caramels without problems.

However, there is still a need for more hard caramels that are attractive in terms of taste, organoleptics and appearance and in particular that also meet certain consumer profiles, in particular those that combine health benefits with a high storage stability.

The present invention solves the underlying problem by the subject matter of the independent claims.

Particularly, the present invention relates to a process for preparing a hard caramel containing a trehalulose-containing composition, comprising the steps of:
a) providing an aqueous medium containing a trehalulose-containing composition in an amount of 50 to 100 wt. % (based on the total dry substance) comprising 5 to 50 wt. % of isomaltulose and 20 to 95 wt. % of trehalulose (each based on dry substance of the trehalulose-containing composition),
b) applying a reduced pressure of at most 0.4 bar with mixing at a temperature of at most 135° C., in particular at most 130° C.,
c) cooling the aqueous medium to a temperature of 70 to 90° C. at atmospheric pressure to obtain a plastic mass, and
d) moulding the plastic mass obtained in step c) and obtaining a hard caramel containing a trehalulose-containing composition.

The process according to the invention for preparing a hard caramel containing a trehalulose-containing composition thus provides for first providing an aqueous medium comprising a trehalulose-containing composition in an amount of 50 to 100 wt. %, in particular 50 to 98 wt. % (each based on the total dry substance of the aqueous medium).% (in each case based on total dry substance of the aqueous medium), wherein the trehalulose-containing composition contains isomaltulose in an amount of 5 to 50 wt. % and trehalulose in an amount of 20 to 95 wt. % (each based on dry substance of the trehalulose-containing composition). In a particularly preferred embodiment, the aqueous medium is an aqueous solution or an aqueous syrup. In a particularly preferred embodiment, the aqueous medium is an aqueous solution. In a particularly preferred embodiment, the aqueous medium is an aqueous syrup.

A reduced pressure of at most 0.4 bar at a temperature of at most 135° C. is then applied to the aqueous medium containing a trehalulose-containing composition provided in step a). The applying of the reduced pressure to the aqueous medium is carried out with mixing, wherein the mixing can be carried out by any suitable means known to the person skilled in the art for the mixing of aqueous media. Particularly preferably, the mixing is continuous. Subsequently, in step c), the aqueous medium is cooled to a temperature of 70 to 90° C. at atmospheric pressure, whereby a plastic mass is obtained. Finally, in step d), the plastic mass obtained in step c) is moulded, in particular cast or stamped, in particular stamped, into a hard caramel containing a trehalulose-containing composition.

The method provided according to the invention allows the preparing of a plastic mass with particularly good stamping properties, from which hard caramels can be prepared which are characterised by an improved taste, an attractive visual appearance, in particular an attractive golden-yellow colouring, and the advantageous health-promoting composition of a trehalulose-containing composition.

The present invention allows in a surprisingly advantageous manner to prepare an advantageous hard caramel from a trehalulose-containing composition, in particular Vitalose® in a simple and inexpensive process.

Without being bound by theory, the process according to the invention leads to a high recovery of the trehalulose-containing composition, in particular trehalulose, which was present in the aqueous medium provided in process step a), in the hard caramel containing a trehalulose-containing composition obtained in process step d).

In a particularly preferred embodiment, the aqueous medium provided in step a), in particular the aqueous solution or the aqueous syrup, has a dry substance content of 20 to 80 wt. %, in particular 30 to 70 wt. %, in particular 40 to 65 wt. %, in particular 45 to 65 wt. % (each based on total mass of the aqueous medium, in particular the aqueous solution or the aqueous syrup).

In a preferred embodiment of the present invention, the aqueous medium provided in step a), in particular the aqueous solution or the aqueous syrup, has a trehalulose-containing composition in an amount of 50 to 100 wt. %, in particular 50 to 98 wt. % (each based on total dry substance of the aqueous medium, in particular the aqueous solution or the aqueous syrup), comprising 15 to 25 wt. % of isomaltulose and 75 to 85 wt. % of trehalulose (each based on dry substance of the trehalulose-containing composition).

In a further preferred embodiment of the present invention, the aqueous medium provided in step a), in particular the aqueous solution or the aqueous syrup, has a trehalulose-containing composition in an amount of 50 to 100 wt. %, in particular 50 to 98 wt. % (each based on the total dry substance), the trehalulose-containing composition having trehalulose and isomaltulose in a quantitative ratio (wt. %) of 3:1 to 5:1, preferably 3.5:1 to 4.5:1, preferably 4:1.

In a preferred embodiment, the aqueous medium provided in step a), in particular the aqueous solution or the aqueous syrup, contains trehalulose in an amount of 70 to 85 wt. %, in particular 75 to 85 wt. %, and isomaltulose in an amount of 15 to 30 wt. %, in particular 15 to 25 wt. % (each based on the dry substance of the medium, in particular the solution or the syrup).

Preferably, the trehalulose-containing composition is Vitalose®. Particularly preferably, the trehalulose-containing composition is a trehalulose-containing composition described in WO 2010/118866 A1, in particular a trehalulose-containing composition prepared according to the process disclosed in WO 2010/118866 A1. Preferably, it is a composition, in particular Vitalose®, comprising isomaltulose in an amount of 5 to 50 wt. % and trehalulose in an amount of 20 to 95 wt. % (each based on dry substance of the trehalulose-containing composition, in particular Vitalose®).

The disclosure content of WO 2010/118866 A1 is hereby fully incorporated into the disclosure content of the present teachings, in particular with regard to the starting materials and the processes for preparing the trehalulose-containing compositions described in WO 2010/118866 A1, both in their general and in the respective individual specific methods of preparation and compositions.

Particularly, a trehalulose-containing composition in the context of the present invention is understood to mean a mainly trehalulose-containing composition obtained by enzymatically catalysed isomerisation of sucrose-containing compositions, in particular obtained using Pseudomonas mesoacidophila.

In a particularly preferred embodiment, the aqueous medium may be a composition obtained from an enzymatic reaction of sucrose-containing solutions, in particular a composition obtained from enzymatically catalysed isomerisation of sucrose-containing compositions, in particular using Pseudomonas mesoacidophila, in particular a reaction mixture resulting directly from an enzymatic reaction, preferably after purification, if necessary, using, for example, ion exchanger and/or invertase treatments.

Thus, in one embodiment of the present invention, the provided aqueous medium in question is an aqueous medium obtained immediately after an enzyme-catalysed sucrose isomerisation of a sucrose-containing composition to a trehalulose-containing composition. In further embodiments, at least one additive or auxiliary substance may be added to such an aqueous medium comprising a trehalulose-containing composition.

In a particularly preferred embodiment, a trehalulose-containing composition also comprises, in addition to trehalulose and isomaltulose, further sugars, in particular monomers, dimers and oligomers, derived from the said enzymatic reaction, in particular fructose, glucose, isomelezitose, sucrose, turanose, leucrose, isomaltose and/or raffinose.

In a particularly preferred embodiment, the trehalulose-containing composition is a composition comprising 81 wt. % of trehalulose and 17 wt. % of isomaltulose and at least one of the other aforementioned sugars (based on total dry matter of the trehalulose-containing composition).

In a further preferred embodiment of the present invention, the aqueous medium provided in step a), in particular the aqueous solution or the aqueous syrup, is heated to a temperature of at most 100° C. in a process step al) before step b). Particularly preferably, the aqueous medium provided in step a), in particular the aqueous solution or the aqueous syrup, is heated to a temperature of 80 to 100° C., preferably 85 to 95° C., before step b) in a process step al).

Preferably, the heating of the aqueous medium provided in step a), in particular the aqueous solution or the aqueous syrup, takes place before step b) in a process step al) under atmospheric pressure.

In a preferred embodiment of the present invention, in step b) the temperature is 120 to 135° C., preferably 125 to 135° C.

In a preferred embodiment of the present invention, the pressure in step b) is in a range of 0.1 to 0.4 bar, preferably 0.15 to 0.4 bar, preferably 0.2 to 0.4 bar, preferably 0.25 to 0.4 bar, preferably 0.3 to 0.4 bar.

Preferably, the pressure in step b) is at most 0.38 bar, preferably at most 0.36 bar, preferably at most 0.34 bar, preferably at most 0.32 bar, preferably at most 0.3 bar, preferably at most 0.28 bar, preferably at most 0.26 bar, preferably at most 0.24 bar, preferably at most 0.22 bar.

In a preferred embodiment of the present invention, the mixing in step b) is continuous.

In a particularly preferred embodiment of the present invention, the duration of process step b) is 5 to 30 min, in particular 7 to 28 min, in particular 8 to 27 min, in particular 5 to 20 min, in particular 9 to 20 min, in particular 5 to 15 min, in particular 8 to 14 min.

In a particularly preferred embodiment of the present invention, the cooling in process step c) is a passive cooling. According to this embodiment, it may be provided that the aqueous medium present at a certain temperature in step b), in particular the aqueous solution or the aqueous syrup, is cooled by not applying heat, for example by leaving it standing at room temperature or by storing or transporting it on a cooling table or cooling belt. In another embodiment of the present invention, the cooling in process step c) may also be an active cooling using cooling means.

In another preferred embodiment of the present invention, the cooling of the aqueous medium in step c) is carried out to a temperature of 72 to 88° C., preferably 74 to 86° C., preferably 76 to 84° C., preferably 78 to 82° C., preferably 80° C.

In a preferred embodiment of the present invention, the plastic mass obtained in step c) has a water content of 1 to 4%, preferably 1.5 to 3%, preferably 1.6 to 2.8%, particularly preferably 1.9 to 2.6% (each based on total mass of the plastic mass).

In another preferred embodiment of the present invention, the plastic mass obtained in step c) has a water content of at most 4%, preferably at most 3.9%, preferably at most 3.8%, preferably at most 3.7%, preferably at most 3.6%, preferably at most 3.5%, preferably at most 3.4%, preferably at most 3.3%, preferably at most 3.2%, preferably at most 3.1%, preferably at most 3.0%, preferably at most 2.9%, preferably at most 2.8%, preferably at most 2.7%, preferably at most 2.6%, preferably at most 2.5%, preferably at most 2.4%, preferably at most 2.3%, preferably at most 2.2%, preferably at most 2.1%, preferably at most 2.0%, preferably at most 1.9%, preferably at most 1.8%, preferably at most 1.7%, preferably at most 1.6%, preferably at most 1.5% (each based on total mass of the plastic mass).

In a preferred embodiment of the present invention, the aqueous medium provided in process step a) has, in addition to the trehalulose-containing composition, in particular the aqueous solution or the aqueous syrup, at least one auxiliary substance or additive. This at least one auxiliary substance or additive is preferably selected from the group consisting of colourants, flavourings, aromas, food-grade acids or acid salts, preservatives, active ingredients, fillers, fats, fat substitutes, oils, binders, milk products, emulsifiers, intense sweeteners, sweeteners, medically active substances, sugar alcohols, polysaccharides, oligosaccharides, other sugars and mineral salts, in particular salts with Ca²⁺, NaCl, trisodium citrate, salts with phosphate or salts with Mg²⁺.

Accordingly, in a preferred embodiment, it is provided that the aqueous medium may have, in addition to the trehalulose-containing composition, at least one auxiliary substance or additive which is added to the medium in addition to the trehalulose-containing composition.

An at least one auxiliary substance or additive preferably provided according to the invention may be present in the aqueous medium in an amount of 0 to 50 wt. %, in particular 1 to 50 wt. %, in particular 2 to 50 wt. %, in particular 10 to 50 wt. %, in particular 10 to 40 wt. %, in particular 20 to 40 wt. %, in particular 30 to 35 wt. % (based on total dry substance of the aqueous medium).

In a particularly preferred embodiment, it may be provided that the at least one added auxiliary substance or additive is a sugar, in particular a sugar may be added which is already present in the trehalulose-containing composition and is added to the aqueous medium in addition to increasing the amount of this sugar present in the aqueous medium, for example sucrose, glucose or fructose.

Where, in the context of the present invention, quantitative data are provided on the content of mono-, di-, oligo- or polymeric sugars, based on the trehalulose-containing composition containing the aqueous medium or based on a hard caramel prepared according to the invention, the total content of the respective sugar is meant, irrespective of whether this sugar content was brought about by introduction via the trehalulose-containing composition or by additional addition to the aqueous medium.

In a preferred embodiment of the present invention, the aqueous medium provided in step a), in particular the aqueous solution or the aqueous syrup, comprises at least one food-grade acid and/or an acid salt. Preferably, the aqueous medium, in particular the aqueous solution or aqueous syrup, comprises at least one organic acid, in particular an organic acid selected from the group consisting of citric acid, malic acid, lactic acid, tartaric acid and ascorbic acid.

In another preferred embodiment of the present invention, the aqueous medium provided in step a), in particular the aqueous solution or aqueous syrup, is free, or substantially free, of acid.

“Substantially free” in the context of the present invention means that the medium has components, in this case free acids and/or acidic salts of acids, in such small proportions in each case that the person skilled in the art no longer understands this to mean a medium containing these components, in this case an acidic aqueous medium, in particular an aqueous solution or aqueous syrup.

Preferably, the aqueous medium provided in step a), in particular the aqueous solution or the aqueous syrup, contains less than 5 wt. %, preferably less than 4 wt. %, preferably less than 3 wt. %, preferably less than 2 wt. %, preferably less than 1 wt. %, preferably less than 0.5 wt. %, preferably less than 0.1 wt. %, preferably less than 0.05 wt. %, preferably less than 0.01 wt. % of acid and/or acid salts (each based on total dry substance of the aqueous medium, in particular the aqueous solution or the aqueous syrup).

In a further preferred embodiment of the present invention, the aqueous medium provided in step a), in particular the aqueous solution or the aqueous syrup, is free, in particular substantially free, of fat. In a further embodiment, the aqueous medium provided in step a), in particular the aqueous solution or the aqueous syrup, is free, in particular substantially free, of oil. In both cases, the amount of fat and/or oil in the aqueous medium, in particular the aqueous solution or aqueous syrup, is so low that the person skilled in the art does not assume that the aqueous medium, in particular an aqueous solution or aqueous syrup, contains fat and/or oil. Preferably, the aqueous medium provided in step a), in particular the aqueous solution or aqueous syrup, has less than 5 wt. %, preferably less than 4 wt. %, preferably less than 3 wt. %, preferably less than 2 wt. %, preferably less than 1 wt. %, preferably less than 0.5 wt. %, preferably less than 0.1 wt. %, preferably less than 0.05 wt. %, preferably less than 0.01 wt. %, of fat and/or oil or fat- and/or oil-containing constituents (each based on total dry substance of the aqueous medium, in particular of the aqueous solution or of the aqueous syrup).

In a preferred embodiment of the present invention, the aqueous medium provided in step a), in particular the aqueous solution or the aqueous syrup, contains at least one further sugar, in particular sucrose, glucose and/or fructose.

Preferably, the aqueous medium provided in step a), in particular the aqueous solution or the aqueous syrup, according to the present invention has sucrose in an amount of at most 55 wt. %, preferably at most 50 wt. %, preferably at most 40 wt. %, preferably at most 30 wt. %.%, preferably at most 25 wt. %, preferably at most 20 wt. %, preferably at most 15 wt. %, preferably at most 10 wt. %, preferably at most 5 wt. % (each based on total dry substance of the aqueous medium, in particular of the aqueous solution or aqueous syrup).

Particularly preferably, the aqueous medium provided in step a), in particular the aqueous solution or the aqueous syrup, has sucrose in an amount of 2 to 55 wt. %, in particular 2 to 50 wt. %, preferably 4 to 40 wt. %, preferably 5 to 30 wt. %, preferably 7.5 to 27.5 wt. %, preferably 10 to 25 wt. %, preferably 12.5 to 22.5 wt. %, preferably 15 to 20 wt. % (each based on total dry substance of the aqueous medium, in particular the aqueous solution or the aqueous syrup).

Preferably, the aqueous medium provided in step a), in particular the aqueous solution or the aqueous syrup, according to the present invention has glucose in an amount of at most 50 wt. %, preferably at most 40 wt. %, preferably at most 30 wt. %, preferably at most 25 wt. %, preferably at most 20 wt. %, preferably at most 15 wt. %, preferably at most 10 wt. %, preferably at most 5 wt. % (each based on total dry substance of the aqueous medium, in particular the aqueous solution or the aqueous syrup).

Particularly preferably, the aqueous medium provided in step a), in particular the aqueous solution or the aqueous syrup, has glucose in an amount of 2 to 50 wt. %, preferably 4 to 40 wt. %, preferably 5 to 30 wt. %, preferably 7.5 to 27.5 wt. %, preferably 10 to 25 wt. %, preferably 12.5 to 22.5 wt. %, preferably 15 to 20 wt. % (each based on total dry substance of the aqueous medium, in particular the aqueous solution or the aqueous syrup).

Preferably, the aqueous medium provided in step a), in particular the aqueous solution or the aqueous syrup, according to the present invention has fructose in an amount of at most 50 wt. %, preferably at most 40 wt. %, preferably at most 30 wt. %, preferably at most 25 wt. %, preferably at most 20 wt. %, preferably at most 15 wt. %, preferably at most 10 wt. %, preferably at most 5 wt. % (each based on total dry substance of the aqueous medium, in particular of the aqueous solution or of the aqueous syrup).

Preferably, the aqueous medium provided in step a), in particular the aqueous solution or the aqueous syrup, has fructose in an amount of 2 to 50 wt. %, preferably 4 to 40 wt. %, preferably 5 to 30 wt. %, preferably 7.5 to 27.5 wt. %, preferably 10 to 25 wt. %, preferably 12.5 to 22.5 wt. %, preferably 15 to 20 wt. % (each based on total dry substance of the aqueous medium, in particular of the aqueous solution or the aqueous syrup).

In a preferred embodiment of the present invention, the aqueous medium provided in step a), in particular the aqueous solution or the aqueous syrup, contains at least one polysaccharide in an amount of at most 5 wt. %, preferably at most 4 wt. %, preferably at most 3 wt. %, preferably at most 2 wt. %, preferably at most 1 wt. %, preferably at most 0.5 wt. %, preferably at most 0.2 wt. %, preferably at most 0.1 wt. % (each based on total dry substance of the aqueous medium, in particular of the aqueous solution or aqueous syrup). Preferably, the aqueous medium provided in step a), in particular the aqueous solution or the aqueous syrup, does not contain any polysaccharide.

In a further preferred embodiment of the present invention, the aqueous medium provided in step a), in particular the aqueous solution or the aqueous syrup, contains at least one oligosaccharide in an amount of at most 5 wt. %, preferably at most 4 wt. %, preferably at most 3 wt. %, preferably at most 2 wt. %, preferably at most 1 wt. %, preferably at most 0.5 wt. %, preferably at most 0.2 wt. %, preferably at most 0.1 wt. % (each based on total dry substance of the aqueous medium, in particular of the aqueous solution or aqueous syrup). Preferably, the aqueous medium provided in step a), in particular the aqueous solution or the aqueous syrup, does not contain any oligosaccharide.

Preferably, the aqueous medium provided in step a), in particular the aqueous solution or the aqueous syrup, does not contain any oligosaccharide and no polysaccharide. Particularly preferably, the aqueous medium provided in step a), in particular the aqueous solution or the aqueous syrup, does not contain any oligosaccharide and/or polysaccharide selected from the group consisting of inulin, indigestible dextrin, polydextrose, sucomalt or combinations thereof.

Preferably, the aqueous medium provided in step a), in particular the aqueous solution or the aqueous syrup, comprises at least one sugar alcohol. Preferably, the at least one sugar alcohol is selected from the group consisting of isomalt, 1,6-GPS (6-O-α-D-glucopyranosyl-D-sorbitol), 1,1-GPM (1-O-α-D-glucopyranosyl-D-mannitol), 1,1-GPS (1-O-α-D-glucopyranosyl-D-sorbitol), hydrogenated and/or non-hydrogenated starch hydrolysates (HSH), xylitol, sorbitol, erythritol, mannitol, maltitol, lactitol, maltodextrins or mixtures thereof.

In a particularly preferred embodiment, the aqueous medium provided in process step a), in particular the aqueous solution or the aqueous syrup, contains isomalt.

Preferably, the aqueous medium provided in step a), in particular the aqueous solution or the aqueous syrup, according to the present invention has isomalt, in an amount of at most 50 wt. %, preferably at most 40 wt. %, preferably at most 30 wt. %%, preferably at most 25 wt. %, preferably at most 20 wt. %, preferably at most 15 wt. %, preferably at most 10 wt. %, preferably at most 5 wt. % (each based on total dry substance of the aqueous medium, in particular of the aqueous solution or of the aqueous syrup).

Preferably, the aqueous medium provided in step a), in particular the aqueous solution or the aqueous syrup, has isomalt in an amount of at most 2 to 50 wt. %, preferably 4 to 40 wt. %, preferably 5 to 30 wt. %, preferably 7.5 to 27.5 wt. %, preferably 10 to 25 wt. %, preferably 12.5 to 22.5 wt. %, preferably 15 to 20 wt. % (each based on total dry substance of the aqueous medium, in particular the aqueous solution or the aqueous syrup).

In a particularly preferred embodiment, the aqueous medium provided does not contain any isomalt.

Preferably, the aqueous medium provided in step a), in particular the aqueous solution or the aqueous syrup, has at least one medically active substance, in particular antihistamines, antibiotics, fungicides, microbiocides, hexylresorcinol, dextromethorphan hydrobromide, menthol, nicotine, caffeine, vitamins, zinc, eucalyptus, benzocaine, cetylpyridinium, fluorides, phenylpropanolamine or other pharmaceutically active substances. In the preparation of a medically active hard caramel, the active substance may be contained in the aqueous medium, in particular in the aqueous solution, in an amount of, for example, 1.0 to 15 mg per unit.

In a preferred embodiment of the present invention, the aqueous medium provided in step a), in particular the aqueous solution or the aqueous syrup, comprises at least one flavouring and/or one aroma. Particularly preferably, the aqueous medium provided in step a), in particular the aqueous solution or aqueous syrup, comprises at least one flavouring or aroma selected from the group consisting of plant and fruit oils, citrus oils, flower or leaf oils, oils of cherry, strawberry, menthol, eucalyptus, peppermint, honey or green mint, fruit essences and green tea extract. Preferably, the aqueous medium provided in step a), in particular the aqueous solution or aqueous syrup, comprises the at least one flavouring or aroma in an amount of 0.05 to 3 wt. % (based on total dry substance of the aqueous medium, in particular the aqueous solution or aqueous syrup).

In a further preferred embodiment, the aqueous medium provided in step a), in particular the aqueous solution or the aqueous syrup, comprises at least one binder. Preferably, the aqueous medium provided in step a), in particular the aqueous solution or the aqueous syrup, comprises at least one binder selected from the group consisting of alginates, cellulose, gelatine and vegetable gums.

In a further preferred embodiment, the aqueous medium provided in step a), in particular the aqueous solution or the aqueous syrup, comprises at least one intense sweetener. Particularly preferably, the aqueous medium provided in step a), in particular the aqueous solution or the aqueous syrup, comprises at least one intense sweetener selected from the group consisting of aspartame, cyclamate, acesulfame-K, saccharin, sucralose, glycyrrhizin, monellin, dulcin, naringin dihydrochalcone, neotame, alitame, neohesperidin DC (dihydrochalcone), steviosides, thaumatin or mixtures thereof.

In a preferred embodiment of the present invention, the aqueous medium provided in step a), in particular the aqueous solution or aqueous syrup, is free of intense sweeteners.

In a preferred embodiment of the present invention, the aqueous medium provided in step a), in particular the aqueous solution or aqueous syrup, comprises at least one colourant. Preferably, the at least one colourant is a synthetic colourant, in particular selected from the group consisting of erythrosine, indigo carmine, allura red, E171, tartrazine and titanium dioxide. Preferably, the at least one colourant is a natural colourant, in particular selected from the group consisting of carotenoids, for example beta-carotene, riboflavins, chlorophyll, anthocyanins, for example from beetroot, betanin. Preferably, the aqueous medium provided in step a), in particular the aqueous solution or aqueous syrup, comprises the at least one synthetic colourant in an amount of 0.01 to 0.03 wt. % (based on total dry substance of the aqueous medium, in particular the aqueous solution or aqueous syrup). In a further preferred embodiment, the aqueous medium provided in step a), in particular the aqueous solution or aqueous syrup, comprises the at least one natural colourant in an amount of 0.1 to 1 wt. % (based on total dry substance of the aqueous medium, in particular the aqueous solution or aqueous syrup). Preferably, the aqueous medium provided in step a), in particular the aqueous solution or the aqueous syrup, comprises at least one synthetic and at least one natural colourant.

In a preferred embodiment of the present invention, the aqueous medium provided in step a), in particular the aqueous solution or aqueous syrup, is free of colourants.

In a preferred embodiment, the aqueous medium provided in step a), in particular the aqueous solution or the aqueous syrup, comprises at least one milk product, in particular a dairy product, preferably whole milk powder, cream or butter. Preferably, the aqueous medium provided in step a), in particular the aqueous solution or the aqueous syrup, comprises the at least one milk product, in particular dairy product, preferably whole milk powder, cream or butter, in an amount of 0 to 9 wt. %, in particular 1 to 8 wt. % (each based on total weight of the aqueous medium, in particular the aqueous solution or the aqueous syrup).

In a further preferred embodiment, the aqueous medium provided in step a), in particular the aqueous solution or the aqueous syrup, comprises at least one emulsifier, in particular lecithin, for example soya lecithin. Preferably, the aqueous medium provided in step a), in particular the aqueous solution or the aqueous syrup, comprises the at least one emulsifier in an amount of 0 to 5 wt. %, in particular 1 to 4 wt. % (each based on total dry substance of the aqueous medium, in particular the aqueous solution or the aqueous syrup).

The present invention further relates to a hard caramel containing 50 to 100 wt. %, in particular 50 to 98 wt. % (each based on total dry substance of the hard caramel) of a trehalulose-containing composition comprising 5 to 50 wt. % of isomaltulose and 20 to 95 wt. % of trehalulose (each based on dry substance of the trehalulose-containing composition), preparable, in particular prepared, by the process according to the invention.

The hard caramels according to the invention are characterised by a mild taste and a sucrose-like sweetness profile, exhibit a low insulin response and are nutritionally beneficial. In particular, the hard caramels according to the invention show no tendency to crystallise.

In a preferred embodiment of the present invention, the hard caramel contains 50 to 100 wt. %, in particular 50 to 98 wt. % (each based on total dry substance of the hard caramel) of a trehalulose-containing composition comprising 15 to 25 wt. % of isomaltulose and 75 to 85 wt. % of trehalulose (each based on dry substance of the composition).

In a preferred embodiment of the present invention, the trehalulose-containing composition is substantially, preferably completely, amorphous in the hard caramel.

In a preferred embodiment of the present invention, the trehalulose-containing composition is not crystalline in the hard caramel. Preferably, the trehalulose-containing composition, in particular the trehalulose and the isomaltulose, preferably the trehalulose, preferably the isomaltulose, is amorphous in the hard caramel, preferably in the core of the hard caramel.

In another preferred embodiment of the present invention, the hard caramel is transparent.

In another preferred embodiment of the present invention, the hard caramel according to the invention has a residual water content of 1.5 to 3 wt. %, preferably 1.9 to 2.6 wt. % (based on total weight of the hard caramel).

In a preferred embodiment of the present invention, the hard caramel according to the invention comprises at least one auxiliary substance or additive selected from the group consisting of colourants, flavourings, aromas, food-grade acids or acid salts, preservatives, active ingredients, fillers, fats, fat substitutes, oils, binders, milk products, emulsifiers, intense sweeteners, medically active substances, sugar alcohols, polysaccharides, oligosaccharides, other sugars, mineral salts, in particular salts with Ca²⁺, NaCl, trisodium citrate, salts with phosphate or salts with Mg′.

In a preferred embodiment of the present invention, the hard caramel comprises at least one acid and/or acid salt. Preferably, the hard caramel comprises at least one organic acid, in particular an organic acid selected from the group consisting of citric acid, malic acid, lactic acid, tartaric acid and ascorbic acid.

In a further preferred embodiment of the present invention, the hard caramel is free, or substantially free, of acid. That is, it has free acids and/or acid salts of acids in such small proportions in each case that the person skilled in the art no longer understands this to be an acid-containing hard caramel. Preferably, the hard caramel according to the invention has less than 5 wt. %, preferably less than 4 wt. %, preferably less than 3 wt. %, preferably less than 2 wt. %, preferably less than 1 wt. %, preferably less than 0.5 wt. %, preferably less than 0.1 wt. %, preferably less than 0.05 wt. %, preferably less than 0.01 wt. % of acid and/or acid salts (each based on total dry substance of the hard caramel).

In a further preferred embodiment of the present invention, the hard caramel is free, in particular substantially free, of fat. In a further embodiment, the hard caramel according to the present invention is free, in particular substantially free, of oil. In both cases, the amount of fat and/or oil in the hard caramel is so low that the person skilled in the art does not assume that the hard caramel contains fat and/or oil. Preferably, the hard caramel according to the invention has less than 5 wt. %, preferably less than 4 wt. %, preferably less than 3 wt. %, preferably less than 2 wt. %, preferably less than 1 wt. %, preferably less than 0.5 wt. %, preferably less than 0.1 wt. %, preferably less than 0.05 wt. %, preferably less than 0.01 wt. %, of fat and/or oil or fat- and/or oil-containing constituents (each based on total dry substance of the hard caramel).

In a particularly preferred embodiment of the present invention, the hard caramel according to the invention contains, in addition to the trehalulose-containing composition, at least one auxiliary substance or additive.

In a particularly preferred embodiment, the at least one auxiliary substance or additive may be present in an amount of 0 to 50 wt. %, in particular 1 to 50 wt. %, in particular 2 to 50 wt. %, in particular 10 to 50 wt. %, in particular 10 to 40 wt. %, in particular 20 to 40 wt. %, in particular 30 to 35 wt. % (each based on total dry substance of the hard caramel).

In a preferred embodiment of the present invention, the hard caramel contains, in addition to trehalulose and isomaltulose, at least one further, optionally added, sugar, in particular sucrose, glucose and/or fructose.

Preferably, the hard caramel according to the present invention has sucrose in an amount of at most 55 wt. %, preferably at most 50 wt. %, preferably at most 40 wt. %, preferably at most 30 wt. %, preferably at most 25 wt. %, preferably at most 20 wt. %, preferably at most 15 wt. %, preferably at most 10 wt. %, preferably at most 5 wt. % (each based on total dry matter of the hard caramel).

Particularly preferably, the hard caramel has sucrose in an amount of 2 to 55 wt. %, preferably 2 to 50 wt. %, preferably 4 to 40 wt. %, preferably 5 to 30 wt. %, preferably 7.5 to 27.5 wt. %, preferably 10 to 25 wt. %, preferably 12.5 to 22.5 wt. %, preferably 15 to 20 wt. % (each based on total dry substance of the hard caramel).

Preferably, the hard caramel according to the present invention has glucose in an amount of at most 50 wt. %, preferably at most 40 wt. %, preferably at most 30 wt. %, preferably at most 25 wt. %, preferably at most 20 wt. %, preferably at most 15 wt. %, preferably at most 10 wt. %, preferably at most 5 wt. % (each based on total dry substance of the hard caramel).

Particularly preferably, the hard caramel has glucose in an amount of 2 to 50 wt. %, preferably 4 to 40 wt. %, preferably 5 to 30 wt. %, preferably 7.5 to 27.5 wt. %, preferably 10 to 25 wt. %, preferably 12.5 to 22.5 wt. %, preferably 15 to 20 wt. % (each based on total dry substance of the hard caramel).

Preferably, the hard caramel according to the present invention has fructose in an amount of at most 50 wt. %, preferably at most 40 wt. %, preferably at most 30 wt. %, preferably at most 25 wt. %, preferably at most 20 wt. %, preferably at most 15 wt. %, preferably at most 10 wt. %, preferably at most 5 wt. % (each based on total dry substance of the aqueous medium, in particular the aqueous solution or the aqueous syrup).

Particularly preferably, the hard caramel has fructose in an amount of 2 to 50 wt. %, preferably 4 to 40 wt. %, preferably 5 to 30 wt. %, preferably 7.5 to 27.5 wt. %, preferably 10 to 25 wt. %, preferably 12.5 to 22.5 wt. %, preferably 15 to 20 wt. % (each based on total dry substance of the aqueous medium, in particular the aqueous solution or the aqueous syrup).

In a preferred embodiment of the present invention, the hard caramel contains at least one polysaccharide in an amount of at most 5 wt. %, preferably at most 4 wt. %, preferably at most 3 wt. %, preferably at most 2 wt. %, preferably at most 1 wt. %, preferably at most 0.5 wt. %, preferably at most 0.2 wt. %, preferably at most 0.1 wt. % (each based on total dry substance of the hard caramel). Preferably, the hard caramel according to the invention does not contain any polysaccharide.

In a further preferred embodiment of the present invention, the hard caramel contains at least one oligosaccharide in an amount of at most 5 wt. %, preferably at most 4 wt. %, preferably at most 3 wt. %, preferably at most 2 wt. %, preferably at most 1 wt. %, preferably at most 0.5 wt. %, preferably at most 0.2 wt. %, preferably at most 0.1 wt. % (each based on total dry substance of the hard caramel). Preferably, the hard caramel according to the invention does not contain any oligosaccharide.

Preferably, the hard caramel according to the invention does not contain any oligosaccharide and polysaccharide. Particularly preferably, the hard caramel does not contain any oligosaccharide and/or polysaccharide selected from the group consisting of inulin, indigestible dextrin, polydextrose, sucomalt or combinations thereof.

Preferably, the hard caramel according to the invention comprises at least one sugar alcohol. Preferably, the at least one sugar alcohol is selected from the group consisting of isomalt, 1,6-GPS, 1,1-GPM, 1,1-GPS, hydrogenated and/or non-hydrogenated starch hydrolysates (HSH), xylitol, sorbitol, erythritol, mannitol, maltitol, lactitol, maltodextrins or mixtures thereof.

Preferably, the hard caramel according to the present invention has isomalt in an amount of at most 50 wt. %, preferably at most 40 wt. %, preferably at most 30 wt. %, preferably at most 25 wt. %, preferably at most 20 wt. %, preferably at most 15 wt. %, preferably at most 10 wt. %, preferably at most 5 wt. % (each based on total dry substance of the aqueous medium, in particular the aqueous solution or the aqueous syrup).

Particularly preferably, the hard caramel has isomalt in an amount of from 2 to 50 wt. %, preferably from 4 to 40 wt. %, preferably from 5 to 30 wt. %, preferably from 7.5 to 27.5 wt. %, preferably from 10 to 25 wt. %, preferably from 12.5 to 22.5 wt. %, preferably from 15 to 20 wt. % (each based on total dry substance of the aqueous medium, in particular the aqueous solution or the aqueous syrup).

In a particularly preferred embodiment, the hard caramel according to the invention has no sugar alcohol, in particular no isomalt.

Preferably, the hard caramel according to the invention has at least one medically active substance, in particular antihistamines, antibiotics, fungicides, microbiocides, hexylresorcinol, dextromethorphan hydrobromide, menthol, nicotine, caffeine, vitamins, zinc, eucalyptus, benzocaine, cetylpyridinium, fluorides, phenylpropanolamine or other pharmaceutically active substances. When used as a medically active hard caramel, the active substance may be present in the hard cramelle in an amount of, for example, 1.0 to 15 mg per unit.

In a preferred embodiment of the present invention, the hard caramel comprises at least one flavouring/aroma agent. Particularly preferably, the hard caramel comprises at least one flavouring/aroma agent selected from the group consisting of plant and fruit oils, citrus oils, flower or leaf oils, oils of cherry, strawberry, menthol, eucalyptus, peppermint, honey or green mint, fruit essences and green tea extract. Preferably, the hard caramel comprises the at least one flavouring/flavouring agent in an amount of 0.05 to 3 wt. % (based on total dry matter of the hard caramel).

In another preferred embodiment, the hard caramel comprises at least one binder. Preferably, the hard caramel comprises at least one binder selected from the group consisting of alginates, cellulose, gelatine and vegetable gums.

In a further preferred embodiment, the hard caramel according to the invention comprises at least one intense sweetener. Particularly preferably, the hard caramel according to the invention comprises at least one intense sweetener selected from the group consisting of aspartame, cyclamate, acesulfame-K, saccharin, sucralose, glycyrrhizin, monellin, dulcin, naringin dihydrochalcone, neotame, alitame, neohesperidin DC (dihydrochalcone), steviosides, thaumatin or mixtures thereof.

In a preferred embodiment of the present invention, the hard caramel according to the invention is free of intense sweeteners.

In a preferred embodiment of the present invention, the hard caramel comprises at least one colourant. Preferably, the at least one colourant is a synthetic colourant, in particular selected from the group consisting of erythrosine, indigo carmine, allura red, E171, tartrazine and titanium dioxide. Preferably, the at least one colourant is a natural colourant, in particular selected from the group consisting of carotenoids, for example beta-carotene, riboflavins, chlorophyll, anthocyanins, for example from beetroot, betanin. Preferably, the hard caramel according to the invention comprises the at least one synthetic colourant in an amount of 0.01 to 0.03 wt. % (based on total dry matter of the hard caramel). In a further preferred embodiment, the hard caramel according to the invention comprises the at least one natural colourant in an amount of 0.1 to 1 wt. % (based on total dry substance of the hard caramel). Preferably, the hard caramel according to the invention comprises at least one synthetic colourant and at least one natural colourant.

In a preferred embodiment of the present invention, the hard caramel according to the invention is free of colourants.

In a preferred embodiment, the hard caramel according to the invention comprises at least one milk product, in particular a dairy product, preferably whole milk powder, cream or butter. Preferably, the hard caramel according to the invention comprises the at least one milk product, in particular dairy product, preferably whole milk powder, cream or butter, in an amount of 0 to 9 wt. %, in particular 1 to 8 wt. % (each based on total weight of the hard caramel).

In a further preferred embodiment, the hard caramel according to the invention comprises at least one emulsifier, in particular lecithin, for example soya lecithin. Preferably, the hard caramel according to the invention comprises the at least one emulsifier in an amount of 0 to 5 wt. %, in particular 1 to 4 wt. % (each based on total dry substance of the hard caramel).

In a preferred embodiment of the present invention, the hard caramel according to the invention, in particular the hard caramel which can be prepared, in particular prepared, according to the process according to the invention, has a recovery of the trehalulose-containing composition originally used, in particular of the carbohydrates contained in the trehalulose-containing composition originally used, in particular of the trehalulose and isomaltulose contained in the trehalulose-containing composition originally used, of at least 90%, preferably at least 91%, preferably at least 92%, preferably at least 93%, preferably at least 94%, preferably at least 95%, preferably at least 96%, preferably at least 97%, preferably at least 98%, preferably at least 99%.

In a particularly preferred embodiment of the present invention, a hard caramel with a recovery rate of at least 90%, preferably at least 91%, preferably at least 92%, preferably at least 93%, preferably at least 94%, preferably at least 95%, preferably at least 96%, preferably at least 97%, preferably at least 98%, preferably at least 99% trehalulose is prepared by means of the process according to the invention.

In a particularly preferred embodiment of the present invention, a hard caramel having a recovery rate of at least 90%, preferably at least 91%, preferably at least 92%, preferably at least 93%, preferably at least 94%, preferably at least 95%, preferably at least 96%, preferably at least 97%, preferably at least 98%, preferably at least 99% isomaltulose is prepared by the process according to the invention.

In the context of the present invention, weight percentages are based on total dry substance of the hard caramel, unless otherwise indicated.

In the context of the present invention, an aqueous medium containing a trehalulose-containing composition is understood to mean that a trehalulose-containing composition is present in a medium, in particular a solvent, for example in the form of an aqueous medium, i.e. an aqueous solvent, wherein the aqueous medium may be in the form of a syrup or a solution. In a preferred embodiment, the aqueous medium may be water.

In a particularly preferred embodiment, the aqueous medium may be a trehalulose-containing composition resulting from an enzymatic reaction of sucrose-containing solutions, in particular a trehalulose-containing composition resulting from enzymatically catalysed isomerisation of sucrose-containing compositions using an α-glucosyltransferase, in particular using Pseudomonas mesoacidophila, in particular a reaction mixture resulting directly from an enzymatic reaction, preferably after optional purification using, for example, ion exchanger and/or invertase treatments.

In one embodiment of the present invention, the aqueous medium provided in process step a) is an aqueous medium obtained immediately after an enzyme-catalysed, in particular α-glucosyltransferase-catalysed, isomerisation of a sucrose-containing composition to a trehalulose-containing composition or by subsequent purification by means of ion exchanger and/or invertase treatment. In a further embodiment, at least one additive or auxiliary substance may be added to such an aqueous medium in addition to said trehalulose-containing composition.

In the context of the present invention, the term “hard caramel” means an substantially amorphous, glass-like product.

In the context of the present invention, a “plastic mass” refers to a deformable mass.

In the context of the present invention, the term “cooling” refers to a reduction in temperature. In this context, the term comprises both active cooling, in particular by the active removal of thermal energy, and passive cooling, in particular “allowing to cool”.

In the context of the present invention, the term “disaccharide” is understood to mean a carbohydrate composed of two monosaccharides, the two monosaccharides being linked together by a glycosidic bond.

According to the invention, an “oligosaccharide” is understood to be a carbohydrate which is composed of three to ten monosaccharides, the individual monosaccharides being linked together by glycosidic bonds.

According to the invention, the term “polysaccharide” means a carbohydrate which is composed of more than ten monosaccharides, the individual monosaccharides being linked together by glycosidic bonds.

In the context of the present invention, “recovery” is understood to mean the percentage of a substance, in particular the percentage of the carbohydrates contained in the originally used trehalulose-containing composition, preferably the percentage of the trehalulose and isomaltulose contained in the originally used trehalulose-containing composition, which is chemically unchanged in the hard caramel after carrying out the process according to the invention, in particular after preparing the hard caramel according to the invention. Accordingly, a high “recovery” means that no or only a slight chemical change of the substances concerned, in particular of the carbohydrates contained in the originally used trehalulose-containing composition, preferably of the trehalulose and isomaltulose contained in the originally used trehalulose-containing composition, has taken place during the preparing process, in particular that only a small proportion of the substances originally used in the process has been chemically changed and the predominant proportion of the substances is present chemically unchanged in the hard caramel.

In the context of the present invention, the terms “comprising” and “having” are understood to mean that in addition to the elements explicitly covered by these terms, further elements not explicitly mentioned may be added. In the context of the present invention, it is also understood by these terms that only the explicitly mentioned elements are covered and that no further elements are present. In this particular embodiment, the meaning of the terms “comprising” and “having” is synonymous with the term “consisting of”. In addition, the terms “comprising” and “having” also cover compositions which, in addition to the explicitly mentioned elements, also contain further elements which are not mentioned but which are of a functionally and qualitatively unordered nature. In this embodiment, the terms “comprising” and “having” are synonymous with the term “consisting essentially of”.

In the context of the present invention, the term “and/or” is understood to mean that all members of a group connected by the term “and/or” are disclosed cumulatively in any combination, both alternatively to each other and to each other. This means for the expression “a), b) and/or c)” that the following disclosure content is to be understood thereunder: a), a) or b) or c) or b) (a) and b) or c) (a) and c) or d) (b) and c) or e) (a) and b) and c).

Where a value is given for a pressure in the context of the present invention, it is to be understood as an absolute pressure and not as a pressure relative to atmospheric pressure. A negative pressure is a pressure that is lower than the prevailing atmospheric pressure (1 bar).

If, in the context of the present invention, the first and second decimal places or the second decimal place are not indicated for a number, this is to be set as zero.

Where quantitative indications, in particular percentages, of components of a product or composition are given in the context of the present invention, these add up to 100% of the composition and/or product together with the other explicitly stated or expertly apparent further components of the composition or product, unless explicitly stated otherwise or expertly apparent.

Where in the context of the present invention a “presence”, a “containing” or a “having” of a component in an amount of 0 wt. % is expressly mentioned or implied, this means that the respective component is not present, in particular not present, in a measurable amount.

Further preferred embodiments of the present invention are apparent from the subclaims.

The invention is described below without limiting the general idea of the invention by means of the embodiments.

### EXAMPLE 1

4 kg of a Vitalose® syrup was prepared as an aqueous medium containing a trehalulose-containing composition in water with a dry matter content of 69.56 wt. % (based on total mass of the Vitalose® syrup) and containing 0.62 wt. % fructose, 0.63 wt. % glucose, 0.26 wt. % sucrose, 0.03 wt. % turanose, 1.13 wt. % leucrose, 76.2 wt. % trehalulose, 20.4 wt. % isomaltulose, 0.31 wt. % isomaltose, 0.04 wt. % raffinose, 0.01 wt. % DP1 (further undetermined monomeric sugar units) and 0.04 wt. % DP2 (further undetermined dimeric sugar units) (each based on total dry substance of the syrup, determined by gas chromatography, GC), weighed in a batch cooker (process step a)) and heated to 100° C. at atmospheric pressure with mixing (process step al)). The aqueous suspension of a trehalulose-containing composition (Vitalose®) thus prepared was then heated to 125° C. at a pressure of 0.3 bar (process step b)). The vacuum was then released, the batch cooker emptied and the resulting cooked, plastic mass cooled to 70 to 80° C. on a steel table (process step c)).

The cooked mass was then stamped into hard caramels on a roller (process step d)).

### EXAMPLE 2

TABLE 1
Recipes

| | | | glucose | | | added |
|---|---|---|---|---|---|---|
| trial | designation | | syrup | Vitalose ® | sucrose | water |
| 1 | reference | | 2367 | | 2367 | 500 |
| 2 | approx. | | | 1400 | 1308 | 200 |
| | 50% | Vitalose ® | | | | |
| | approx. | | | | | |
| | 50% | Sucr.. | | | | |
| 3 | 80% | Vitalose ® | | 2400 | 600 | 0 |
| | 20% | Sucr. | | | | |
| 4 | 100% | Vitalose ® | | 3650 | 0 | 0 |

The amount of ingredients is given in grams and % figures are related to the total mass of the hard caramel produced in the trial.

TABLE 2
Preparation

| | | | | | | isomaltulose |
|---|---|---|---|---|---|---|
| | | max. T | pressure | duration | water | and trehalulose |
| trial | designation | [° C.] | [bar] | [min] | content | recovery |
| 1 | reference | 140 | 0.2 | 25 | 1.9% | |
| 2 | approx. 50% Vitalose ® | 125 | 0.3 | 10 | 1.9% | 100% |
| | approx. 50% sucr. | | | | | |
| 3 | 80% Vitalose ® | 125 | 0.3 | 9 | 2.2% | 100% |
| | 20% sucr. | | | | | |
| 4 | 100% Vitalose ® | 127 | 0.3 | 9 | 2.2% | 100% |

The hard caramels indicated in Table 1 were prepared according to the process indicated in Example 1 with the temperature, pressure and duration of process step b) indicated in Table 2. The trehalulose-containing composition used was the Vitalose® given in Example 1.

Trial 1 is a reference test not according to the invention.

As shown in Table 1, appropriate amounts of sucrose and/or water were added to the Vitalose® in Experiments 2 and 3.

The water content given in Table 2 is the water content of the hard caramel obtained in process step d).

The trials according to the invention showed a high recovery (see Table 2) of both isomaltulose and trehalulose in the hard caramel, whereby the plastic mass obtained was very easy to process and mould and showed no tendency to crystallise.

1. A process for preparing a hard caramel containing a trehalulose-containing composition, comprising the steps of:
a) providing an aqueous medium containing a trehalulose-containing composition in an amount of 50 to 100 wt. % (based on the total dry substance) comprising 5 to 50 wt. % of isomaltulose and 20 to 95 wt. % of trehalulose (each based on dry substance of the trehalulose-containing composition),
b) applying a reduced pressure of at most 0.4 bar with mixing at a temperature of at most 135° C., in particular at most 130° C.,
c) cooling the aqueous medium to a temperature of 70 to 90° C. at atmospheric pressure to obtain a plastic mass, and
d) moulding the plastic mass obtained in step c) and obtaining a hard caramel containing a trehalulose-containing composition.

2. The process according to claim 1, wherein the aqueous medium provided in step a) has a trehalulose-containing composition in an amount of 50 to 100 wt. % (based on total dry substance) comprising 15 to 25 wt. % of isomaltulose and 75 to 85 wt. % of trehalulose (each based on dry substance of the composition).

3. The process according to claim 1, wherein the aqueous medium provided in step a) is heated to a temperature of 80 to 100° C., preferably 85 to 95° C., before step b) in a process step al).

4. The process according to claim 1, wherein in step b) the temperature is 120 to 135° C., preferably 125 to 135° C.

5. The process according to claim 1, wherein the mixing in step b) is continuous.

6. The process according to claim 1, wherein the aqueous medium in step a) has at least one sweetener selected from the group consisting of sucrose, fructose, glucose, isomalt or a mixture thereof in an amount of at most 50 wt. % (based on total dry substance).

7. A hard caramel containing 50 to 98 wt. % (based on total dry substance of the hard caramel) of a trehalulose-containing composition comprising 5 to 50 wt. % of isomaltulose and 20 to 95 wt. % of trehalulose (each based on dry substance of the composition), prepared by a process according to claim 1.

8. The hard caramel according to claim 7, wherein the hard caramel contains 50 to 98 wt. % (based on total dry substance of the hard caramel) of a trehalulose-containing composition comprising 15 to 25 wt. % of isomaltulose and 75 to 85 wt. % of trehalulose (each based on dry substance of the composition).

9. The hard caramel according to claim 7, wherein the hard caramel has at least one sweetener selected from the group consisting of sucrose, fructose, glucose, isomalt or a mixture thereof in an amount of at most 55 wt. % (based on total dry substance of the hard caramel).

10. The hard caramel according to claim 7, wherein the trehalulose-containing composition is not crystalline in the hard caramel.

11. The hard caramel according to claim 7, wherein the hard caramel is transparent.

12. The hard caramel according to claim 7, wherein the hard caramel has a residual water content of 1.5 to 3 wt. %, preferably 1.9 to 2.6 wt. % (based on total weight of the hard caramel).
